(19) United States
(12) Patent Application Publication
(10) Pub. No.: US 2015/0234392 A1
(43) Pub. Date: Aug. 20, 2015

(54) PRESSURE REDUCTION DEVICE

(71) Applicant: MINE SUPPORT PRODUCTS (PTY) LTD, Vereeniging (ZA)

(72) Inventor: Christian NISSEN, Vereeniging (ZA)

(21) Appl. No.: 14/624,788

(22) Filed: Feb. 18, 2015

(30) Foreign Application Priority Data
Feb. 18, 2014 (ZA) 2014/01191

(51) Int. Cl. G05D 7/01

(52) U.S. Cl. CPC G05D 7/0153

(57) ABSTRACT

A pressure reduction device wherein a high pressure fluid is applied to a small area piston which is coupled to a large area piston which acts inside a chamber to produce a low pressure fluid and wherein the small area piston is movable to control the flow of the high pressure fluid to the chamber.

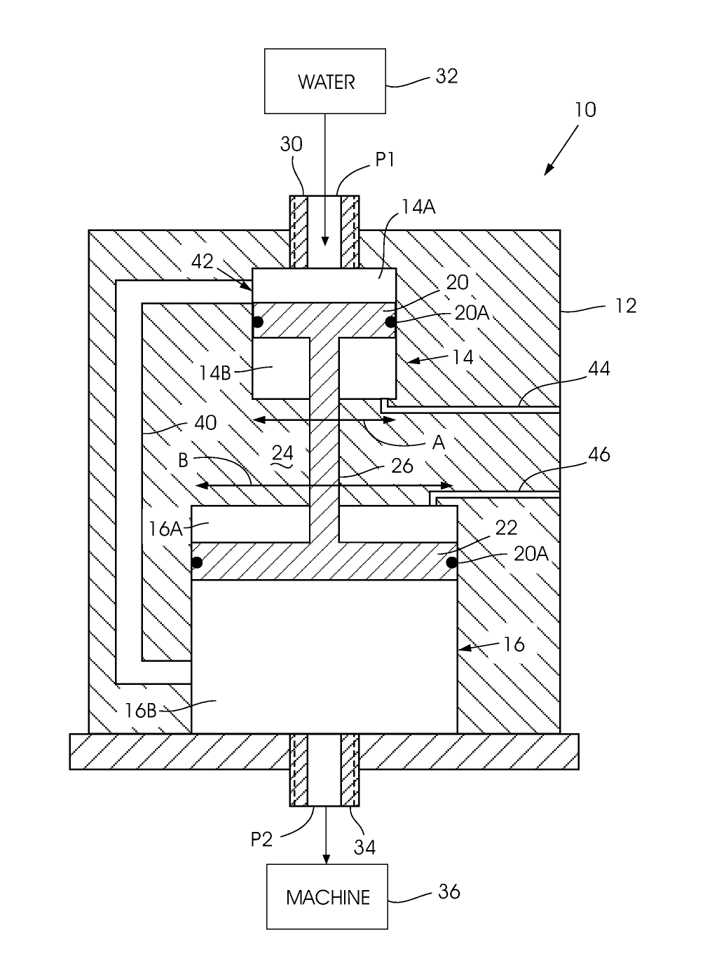

### BACKGROUND OF THE INVENTION

This invention relates to a pressure reduction device which is suitable for use with a source of pressurised water.

Mining activities are frequently carried out with the use of hydro-powered equipment. In deep mines water at a pressure as high as 100 bar is readily available. This pressure is suitable for preloading energisers, rock props and the like but normally is too high to be used with some types of mining machines. A need exists for a device which is of robust construction, suited for underground use, and which can be connected to a source of water at a high pressure to provide a reduced low pressure water output suitable to activate, for example, a mining machine.

### SUMMARY OF INVENTION

The invention provides a pressure reduction device for use with a source of a pressurised water, the device including a housing, a first bore in the housing, a second bore in the housing, a first piston in the first bore which is reciprocally movable and which divides the first bore into a first bore section of variable size and a second bore section of variable size, a second piston in the second bore which is reciprocally movable and which divides the second bore into a first chamber of variable size and a second chamber of variable size, a piston rod which extends into the second bore section and into the first chamber and which connects the first piston to the second piston, a connection on the housing to connect a water source at a first pressure to the first bore section, a connection on the housing to connect the second chamber to mining equipment which functions at a second pressure which is less than the first pressure and a passage which connects the first bore section to the second chamber, wherein the first piston has a cross-sectional area which is less than the cross-sectional area of the second piston and wherein the first piston is movable between a first position at which water can flow from the first bore section to the second chamber and a second position at which the flow of water from the first bore section to the second chamber is reduced or interrupted.

### BRIEF DESCRIPTION OF THE DRAWING

The invention is further described by way of example with reference to the accompanying drawing which schematically illustrates in cross-section a pressure reduction device according to one form of the invention.

DESCRIPTION OF PREFERRED EMBODIMENT

The accompanying drawing illustrates in cross-section and from one side a pressure reduction device 10 according to the invention. The pressure reduction device includes a housing 12 in which is formed a first bore 14 and a second bore 16.

The first bore has a cross-sectional area A and the second bore has a cross-sectional area B. A is smaller than B.

A first piston 20 is reciprocally located in the first bore and is sealingly engaged with a wall of this bore by means of piston rings or seals 20A. The first piston divides the first bore into a first bore section 14A and a second bore section 14B on respective opposing sides of the piston. The sizes of these bore sections are variable according to the position of the piston 20 inside the first bore 14.

A second piston 22 is sealingly engaged with a wall of the second bore 16 by means of piston rings or seals 22A. The second piston divides the second bore into a first chamber 16A and a second chamber 16B on opposing sides of the piston. These chambers are of variable size depending on the position of the piston 22 inside the second bore 16

A piston rod 26 connects the pistons together so that they are only movable in unison. The rod extends through the bore section 14B, the first chamber 16A, and an intermediate part 24 of the housing.

A connection 30 is provided on the housing into the first bore section 14A, for connecting a high pressure source of water 32, to the first bore section. A connection 34 on the housing is used to connect the second chamber 16B to mining equipment 36 e.g. a machine which works at a relatively low water pressure.

A fluid passage 40 extends between the first bore section 14A and the second chamber 16B. An inlet 42 to the passage, inside the first bore section 14A, is positioned so that the piston 20 can be moved from a position at which the inlet 42 is not obscured by the piston to a position at which the first bore section 14A is of minimum size and the inlet 42 is partly closed or sealed by the piston i.e. the area of the inlet, opening onto the first bore section, through which water can flow into the passage, is gradually varied as the first piston moves.

The source of pressurised water, available to actuate the mining machine, supplies water at a pressure P1. The mining machine on the other hand requires water at a pressure P2 where P2<P1. The reduction in pressure is achieved in that A×P1=B×P2. Thus P2=A/B×P1.

The second bore section 14B and the first chamber 16A are preferably vented to atmosphere by respective lines 44 and 46 to avoid compressing and expanding air, in these volumes, as the piston reciprocates.

With the pressure reduction device 10 in the configuration shown in the Figure water can flow from the first bore section 14A to the second chamber 16B via the passage 40. Although the water in the first bore section is nominally at the pressure P1, the water in the second chamber 16B is nominally at a pressure P2 as determined by the expression P2=A/B×P1. If the pressure in the second chamber rises, for whatever reason, then the balance expressed by the equation is affected and the force exerted on the second piston by the water in the second chamber 16B drives the two pistons so that the piston 20 tends to move over the inlet 42 to the passage. In this way the quantity of water which can reach the second chamber is reduced or, even, depending on the circumstances, stopped completely. The effect is that the pressure in the second chamber then is reduced.

The device of the invention exhibits a self-balancing effect in that it automatically continuously acts to reduce the pressure from the source to an acceptable working pressure for the mining equipment.

1. A pressure reduction device for use with a source of a pressurised water, the device including a housing, a first bore in the housing, a second bore in the housing, a first piston in the first bore which is reciprocally movable and which divides the first bore into a first bore section of variable size and a second bore section of variable size, a second piston in the second bore which is reciprocally movable and which divides the second bore into a first chamber of variable size and a second chamber of variable size, a piston rod which extends into the second bore section and into the first chamber and which connects the first piston to the second piston, a connection on the housing to connect a water source at a first pressure to the first bore section, a connection on the housing to connect the second chamber to mining equipment which functions at a second pressure which is less than the first pressure, and a passage which connects the first bore section to the second chamber, wherein the first piston has a cross-sectional area which is less than the cross-sectional area of the second piston and wherein the first piston is movable between a first position at which water can flow from the first bore section to the second chamber and a second position at which the flow of water from the first bore section to the second chamber is reduced or interrupted.

2. A pressure reduction device according to claim 1 wherein the passage has an inlet located in the first bore and wherein the first piston upon movement from the first position of the second position reduces the size of the inlet through which water from the first bore can flow into the passage.

3. A pressure reduction device according to claim 1 wherein the second bore section and the first chamber are each vented to atmosphere.

4. A pressure reduction device according to claim 2 wherein the second bore section and the first chamber are each vented to atmosphere.
